(19) United States
(12) Patent Application Publication
(10) Pub. No.: US 2024/0153680 A1
(43) Pub. Date: May 9, 2024

(54) RARE-EARTH ANISOTROPIC MAGNET POWDER, AND METHOD FOR PRODUCING SAME

(71) Applicants: AICHI STEEL CORPORATION, Tokai-shi, Aichi-ken (JP); TOYOTA JIDOSHA KABUSHIKI KAISHA, Toyota-shi, Aichi-ken (JP)

(72) Inventors: Ryo SHIMBO, Aichi-ken (JP); Masao YAMAZAKI, Aichi-ken (JP); Noritsugu SAKUMA, Mishima-shi, Shizuoka-ken (JP); Akihito KINOSHITA, Mishima-shi, Shizuoka-ken (JP); Akira KATO, Mishima-shi, Shizuoka-ken (JP); Tetsuya SHOJI, Susono-shi, Shizuoka-ken (JP)

(73) Assignees: AICHI STEEL CORPORATION, Tokai-shi, Aichi-ken (JP); TOYOTA JIDOSHA KABUSHIKI KAISHA, Toyota-shi, Aichi-ken (JP)

(21) Appl. No.: 18/279,529

(22) PCT Filed: Mar. 3, 2022
(86) PCT No.: PCT/JP2022/009195

§ 371 Date: Aug. 30, 2023

(30) Foreign Application Priority Data
Mar. 26, 2021 (JP) 2021-053077

(51) Int. Cl. H01F 1/057; B22F 1/142; B22F 1/145; B22F 9/02; C22C 38/00; C22C 38/12; C22C 38/16

(52) U.S. Cl. CPC H01F 1/0571; B22F 1/142; B22F 1/145; B22F 9/023; C22C 38/002; C22C 38/005; C22C 38/12; C22C 38/16; B22F 2201/10; B22F 2201/20; B22F 2301/355; B22F 2998/10; B22F 2999/00; C22C 2202/02

(57) ABSTRACT

Provided is a rare-earth anisotropic magnet powder capable of achieving high magnetic properties while reducing the usage of Nd and Pr. The present invention provides a rare-earth anisotropic magnet powder comprising magnetic particles that contain rare-earth elements, boron, and a transition metal element. The rare-earth elements include a first rare-earth element that comprises Ce and/or La and a second rare-earth element that comprises Nd and/or Pr. The rare-earth elements have a first ratio (R1/Rt) of 5% to 57%. The first ratio (R1/Rt) is a ratio of an amount (R1) of the first rare-earth element to a total amount (Rt) of the rare-earth elements in terms of the number of atoms. The first rare-earth element has a La ratio (La/R1) of 0% to 35%. The La ratio (La/R1) is a ratio of an amount of La to the amount (R1) of the first rare-earth element in terms of the number of atoms. The magnetic particles have a Ga content of 0.35 at % or less with respect to 100 at % as a whole. By adjusting the Ga content to a predetermined value or less, both the reduction of Nd (Pr) and the high magnetic properties can be achieved at a high level.

### TECHNICAL FIELD

The present invention relates to a rare-earth anisotropic magnet powder and relevant techniques.

### BACKGROUND ART

Bonded magnets obtained by fixing rare-earth magnet powder with binder resin are widely used in various electromagnetic devices such as automobiles and electric appliances for which energy saving, weight reduction, etc. are desired, because the bonded magnets have excellent flexibility in shape and exhibit high magnetic properties.

In order to expand the use of bonded magnets, it is necessary to stably acquire the rare-earth elements (sources), which are the main raw materials for rare-earth magnet powder. Unfortunately, rare-earth deposits are eccentrically located, and the supply of rare-earth elements involves geopolitical risks. Until now, research and development have been mainly made on the reduction of usage of heavy rare-earth elements (such as Dy) whose abundance is low in the earth's crust.

However, even if not as much as the heavy rare-earth elements, Nd (or Pr), which is essential for the formation of the main phases of rare-earth magnets, also has a supply risk, and the reduction of its usage is required. Proposals related to this are made, for example, in the following patent document.

### PRIOR ART DOCUMENTS

### Patent Documents

Patent Document 1: JP2016-115774A

### SUMMARY OF INVENTION

### Technical Problem

Patent Document 1 proposes a rare-earth magnet powder obtained through subjecting a raw material alloy in which a part of Nd is replaced (substituted) with Ce to HDDR treatment to obtain a powder and further subjecting the powder to a diffusion and infiltration treatment with an NdCu alloy. Just for information, the abundance ratio of each rare-earth element contained in a rare-earth mineral varies depending on the mineral species, but most of them are generally Ce and La.

Despite the fact that the rare-earth magnet powder of Patent Document 1 contains a rare element (Ga) that is generally said to be effective in improving the coercive force, it does not develop sufficient magnetic properties.

The present invention has been made under such circumstances, and an object of the present invention is to provide a rare-earth anisotropic magnet powder and relevant techniques capable of developing high magnetic properties while reducing the usage of Nd and Pr.

### Solution to Problem

As a result of intensive studies to solve the problem, the present inventors have newly found that a rare-earth anisotropic magnet powder obtained by replacing a substantial amount of Nd or Pr with Ce or La can develop higher magnetic properties as the Ga content reduces, which is contrary to the conventional common general technical knowledge. Developing this achievement, the present inventors have accomplished the present invention, which will be described below.

«Rare-Earth Anisotropic Magnet Powder»

(1) The present invention provides a rare-earth anisotropic magnet powder comprising magnetic particles. The magnetic particles contain rare-earth elements, boron, and a transition metal element. The rare-earth elements include a first rare-earth element that comprises Ce and/or La and a second rare-earth element that comprises Nd and/or Pr. The rare-earth elements have a first ratio (R1/Rt) of 5% to 57%. The first ratio (R1/Rt) is a ratio of an amount (R1) of the first rare-earth element to a total amount (Rt) of the rare-earth elements in terms of the number of atoms. The first rare-earth element has a La ratio (La/R1) of 0% to 35%. The La ratio (La/R1) is a ratio of an amount of La to the amount (R1) of the first rare-earth element in terms of the number of atoms. The magnetic particles have a Ga content of 0.35 at % or less with respect to 100 at % as a whole.

(2) According to the rare-earth anisotropic magnet powder (also simply referred to as “magnet powder”) of the present invention, sufficiently high magnetic properties can be obtained while replacing a part of Nd and/or Pr (also simply referred to as “R2”) with La and/or Ce (also simply referred to as “R1”). That is, according to the magnet powder of the present invention, it is possible to achieve both the reduction of the usage of R2 (also referred to as “reduction of R2” or simply “reduction of Nd”) and the high magnetic properties. Incidentally, Ce and La are more abundant in rare-earth minerals than Nd and can be inexpensively and stably supplied.

The reason why the magnet powder of the present invention develops high magnetic properties is not clear. It is, however, certain that there is a negative correlation between the Ga content and the magnetic properties (the magnetic properties tend to increase as the Ga content decreases) in the case of a composition system with a high content of R1, which is contrary to the conventional common general technical knowledge.

«Method for Producing Rare-Earth Anisotropic Magnet Powder»

The present invention can also be perceived as a method for producing magnet powder. For example, the present invention may provide a production method for obtaining the above-described magnet powder by subjecting a magnet alloy (mother alloy) in which a substantial amount of R2 is replaced with R1 to a hydrogen treatment.

Additionally or alternatively, the present invention may provide a production method for obtaining the above-described magnet powder, for example, by subjecting the magnet powder obtained through the hydrogen treatment as the magnet raw material to a diffusion treatment in which a raw material for diffusion that contributes to the formation of a grain boundary phase is added to the magnet raw material and the raw material for diffusion and the magnet raw material are heated. Specifically, the present invention may provide a method for producing a magnet powder, comprising a diffusion step of heating a mixed raw material obtained by mixing a magnet raw material having a main phase composed of an R₂TM₁₄B₁-type crystal (R: rare-earth element, TM: transition metal element) and a raw material for diffusion serving as a raw material of a grain boundary phase. The magnet raw material is obtained, for example, through a disproportionation step of making a mother alloy absorb hydrogen to cause a disproportionation reaction and a recombination step of dehydrogenating and recombining the mother alloy after the disproportionation step.

«Bonded Magnet, Etc.»

The present invention is also perceived as a bonded magnet using the above-described magnet powder or a method for producing the same. The bonded magnet is composed, for example, of a magnet powder and a resin that binds the powder particles together. The bonded magnet can be obtained, for example, by an injection molding method, a compression molding method, a transfer molding method, or the like.

The present invention is further perceived as a compound used for the production of a bonded magnet. The compound is made by previously attaching a resin that is a binder to the surfaces of powder particles. The magnet powder used for the bonded magnet or the compound may be a composite powder in which two or more types of magnet powders having different alloy compositions, average particle diameters, etc. are mixed in addition to the above-described magnet powder.

«Others»

(1) The “rare-earth elements” as referred to in the present specification (also referred to as “R”) include at least a first rare-earth element (R1: one or more of Ce and La) and a second rare-earth element (R2: one or more of Nd and Pr). R may include another rare-earth element (R3) in addition to R1 and R2. R3 represents one or more included in Y, lanthanides, or actinides, such as Sm, Gd, Tb, or Dy. The sum of R3 is, for example, 3 at % or less in an embodiment, 2 at % or less in another embodiment, or 1 at % or less in still another embodiment with respect to the entire magnetic particles. R contributes to the formation not only of the main phase but also of the grain boundary phase.

The transition metal elements (also referred to as “TM”) include both the elements (such as Fe and Nb) that mainly contribute to the formation of the main phase (R2TM₁₄B₁-type crystal) and the elements (such as Cu) that mainly contribute to the formation of the grain boundary phase. A portion of boron (B) may be substituted with C, for example.

(2) The present invention can be extended to an isotropic magnet powder that is a type of rare-earth magnet powders. However, an anisotropic magnet powder generally has higher magnetic properties than those of an isotropic magnet powder. The anisotropic magnet powder is composed of magnetic particles having a residual magnetic flux density (Br) in one direction (direction of the axis of easy magnetization, c-axis direction) that is higher than the magnetic flux density in other directions. Isotropy and anisotropy are distinguished by a degree of texture (DOT)=[Br (parallel)−Br (perpendicular)]/Br (perpendicular) that is obtained from the magnetic flux density when a magnetic field is applied parallel or perpendicular to the c-axis direction. If the value of DOT is 0, it is isotropic, while if the value of DOT is larger than 0, it is anisotropic.

(3) Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided using such a new lower or upper limit. A range “x to y μm” means x μm to y μm. The same applies to other unit systems (such as nm and kPa).

### BRIEF DESCRIPTION OF DRAWINGS

FIG. 1 is a graph illustrating the relationship between the Ga content and the magnetic properties (Br, iHc).

### EMBODIMENTS FOR CARRYING OUT THE INVENTION

One or more features freely selected from the present specification can be added to the above-described features of the present invention. The contents described in the present specification can be appropriately applied not only to the magnet powder of the present invention, but also to the production method for the same, the bonded magnet using the magnet powder, etc. Even methodological features can also be features regarding a product. Which embodiment is the best or not is different in accordance with objectives, required performance, and other factors.

«Magnet Powder»

The magnet powder is composed of aggregated magnetic particles. The magnetic particles are composed of aggregated fine R₂TM₁₄B₁-type crystals (main phases) that are tetragonal compounds. At each crystal grain boundary, a grain boundary phase exists so as to surround each crystal grain.

(1) Overall Composition

Stoichiometrically speaking, the composition of the tetragonal compound itself that constitutes the main phases is R: 11.8 at %, B: 5.9 at %, and TM: the balance. The magnetic particles contain grain boundary phases, so the total amount (Rt) of rare-earth elements with respect to the whole (100 at %) is, for example, 12 to 18 at % in an embodiment, 12.5 to 16.5 at % in another embodiment, or 13 to 15 at % in still another embodiment. On the other hand, B is, for example, 5.5 to 8 at % in an embodiment or 6 to 7 at % in another embodiment with respect to the magnetic particles as a whole. The balance other than R and B includes transition metal elements (TM), typical metal elements (such as Al), typical nonmetal elements (such as C and O), impurities, etc.

(2) First Ratio

The first ratio (R1/Rt) of the magnetic particles may be, for example, 5% to 57% in an embodiment, 10% to 52% in another embodiment, 15% to 48% in still another embodiment, 20% to 46% in yet another embodiment, 25% to 44% in still yet another embodiment, or 30% to 40% in a further embodiment. The first ratio (R1/Rt) is a ratio of the amount (R1) of the first rare-earth element to Rt in terms of the number of atoms. If the first ratio is unduly large, the magnetic properties will deteriorate. Even when the first ratio is small, high magnetic properties can be obtained, but if the first ratio is unduly small, the reduction of the usage of R2 (reduction of R2) will be insufficient.

(3) La Ratio

The La ratio (La/R1) of the magnetic particles may be, for example, 0% to 35% in an embodiment, 0.1% to 30% in another embodiment, 0.3% to 25% in still another embodiment, 1% to 20% in yet another embodiment, 3% to 10% in still yet another embodiment, or 4% to 6% in a further embodiment. The La ratio (La/R1) is a ratio of the amount of La to R1 (=Ce+La) in terms of the number of atoms. If the La ratio is unduly large, the magnetic properties will deteriorate. Even when the La ratio is small (even when it is zero), high magnetic properties can be obtained. However, in order to effectively utilize La which is abundantly contained in rare-earth minerals together with Ce, the La ratio is preferably more than 0%.

Considering the first ratio and the La ratio, Ce is, for example, 1 to 8 at % in an embodiment, 2 to 7 at % in another embodiment, or 3 to 6 at % in still another embodiment with respect to the magnetic particles as a whole (100 at %), and La may be 0.05 to 2 at % in an embodiment, 0.1 to 1.5 at % in another embodiment, or 0.15 to 1 at % in still another embodiment.

(4) Ga Content

It is considered that the magnetic particles that are substantially free from Ga (Ga-less) develop high magnetic properties. Considering a case in which Ga is contained as an impurity, suffice it to say that the Ga content with respect to the magnetic particles as a whole (100 at %) may be 0.35 at % or less (0 to 0.35 at %) in an embodiment, 0.3 at % or less in another embodiment, 0.2 at % or less in still another embodiment, or 0.15 at % or less in yet another embodiment.

(5) Modifying Element

The magnetic particles (the same applies to the magnet raw material, mother alloy, etc.) may contain modifying elements that are effective in improving the characteristics. Modifying elements include Cu, Al, Si, Ti, V, Cr, Ni, Zn, Ga, Zr, Nb, Mo, Mn, Sn, Hf, Ta, W, Dy, Tb, Co, etc.

For example, the magnetic particles may contain 0.1 to 3 at % of Cu in an embodiment, 0.3 to 2.5 at % of Cu in another embodiment, or 0.5 to 2.0 at % of Cu in still another embodiment with respect to the whole. The magnetic particles may also contain 0.2 to 3 at % of Al in an embodiment, 0.5 to 2.5 at % of Al in another embodiment, or 0.8 to 2 at % of Al in still another embodiment with respect to the whole. Such modifying elements can improve the coercive force of the magnetic particles. The fact that Cu and Al contribute to improvement of the coercive force of magnetic particles (formation of grain boundary phases) is described in detail, for example, in International Publication (WO2011/70847), etc. The entire text (entire content) of the publication is incorporated in the present specification as appropriate. The magnetic particles may further contain 0.05 to 0.7 at % of Nb in an embodiment, 0.07 to 0.5 at % of Nb in another embodiment, or 0.1 to 0.3 at % of Nb in still another embodiment with respect to the whole. This modifying element can improve the residual magnetic flux density of the magnetic particles.

(6) Structure

In the magnetic particles, for example, the size (average crystal grain size) of the R₂TM₁₄B₁-type crystals constituting the main phases is 0.05 to 1 μm in an embodiment or 0.1 to 0.8 μm in another embodiment. The average crystal grain size is determined, for example, according to the method for determining the average diameter d of crystal grains in JIS G 0551.

The magnetic particles have grain boundary phases around (at the grain boundaries of) the crystals (main phases). The grain boundary phases are non-magnetic phases composed of a rare-earth element compound or the like that is excessive (rich) with respect to the stoichiometric composition of the crystals. The thickness of the grain boundary phases is, for example, 1 to 30 nm in an embodiment or 5 to 20 nm in another embodiment. When the magnetic particles contain Cu and/or Al, grain boundary phases composed of a compound (or alloy) of Cu and/or Al and R can be formed.

«Production Method»

The magnet powder (magnet raw material) is obtained, for example, by subjecting a magnet alloy (mother alloy) to hydrogen treatment (HDDR). Unless otherwise stated, the HDDR as referred to in the present specification includes d-HDDR, which is a modified version of the HDDR, and the like.

(1) HDDR

Roughly dividing the HDDR, it is composed of a disproportionation step (HD: Hydrogenation-Disproportionation) and a recombination step (DR: Desorption-Recombination). The disproportionation step is a step of exposing the magnet alloy placed in a treatment furnace to a predetermined hydrogen atmosphere to cause a disproportionation reaction in the magnet alloy that absorbs hydrogen. The disproportionation step is performed, for example, under the conditions of a hydrogen partial pressure: 5 to 100 kPa in an embodiment or 10 to 50 kPa in another embodiment, an atmosphere temperature: 700° C. to 900° C. in an embodiment or 725° C. to 875° C. in another embodiment, and a treatment time: 0.5 to 5 hours in an embodiment or 1 to 3 hours in another embodiment. Although the form of the magnet alloy is not limited, it is usually in the form of granules or small blocks.

The recombination step is a step of desorbing hydrogen from the magnet alloy after the disproportionation step to cause a recombination reaction in the magnet alloy. The recombination step is performed, for example, under the conditions of a hydrogen partial pressure: 3 kPa or less in an embodiment or 1.5 kPa or less in another embodiment, an atmosphere temperature: 700° C. to 900° C. in an embodiment or 725° C. to 875° C. in another embodiment, and a treatment time: 0.5 to 5 hours in an embodiment or 1 to 2 hours in another embodiment.

(2) d-HDDR

The HDDR may be performed as d-HDDR (dynamic-Hydrogenation-Disproportionation-Desorption-Recombination) in which all or part of the HD step or DR step are modified to be respective steps as below.

(a) Low-Temperature Hydrogenation Step

The low-temperature hydrogenation step is a step of holding the magnet alloy in the treatment furnace in a hydrogen atmosphere at a temperature equal to or lower than the temperature at which the disproportionation reaction occurs (e.g., room temperature to 300° C. in an embodiment or room temperature to 100° C. in another embodiment). This step brings the magnet alloy into a state of preliminarily absorbing hydrogen, and the disproportionation reaction in the subsequent high-temperature hydrogenation step (corresponding to the disproportionation step) progresses moderately. This allows the reaction rate of forward structural transformation to be controlled easily. The hydrogen partial pressure in this operation may be preferably about 30 to 100 kPa, for example. The hydrogen atmosphere as referred to in the present specification may be a mixed gas atmosphere of hydrogen and an inert gas (here and hereinafter).

(b) High-Temperature Hydrogenation Step

The high-temperature hydrogenation step is a step of holding the magnet alloy (or the magnet alloy after the low-temperature hydrogenation step) in a hydrogen atmosphere of 750° C. to 860° C. with a hydrogen partial pressure of 10 to 60 kPa. This step allows the magnet alloy to undergo a disproportionation reaction (forward transformation reaction) to become a three-phase decomposition structure (αFe phase, RH₂ phase, and Fe₂B phase).

In this step, the hydrogen partial pressure or the atmosphere temperature may not be constant from beginning to end. For example, at the end of the step when the reaction rate decreases, at least one of the hydrogen partial pressure and the temperature may be increased to adjust the reaction rate and promote the three-phase decomposition (structural stabilization step).

(c) Controlled Evacuation Step

The controlled evacuation step is a step of holding the magnet alloy (or the magnet alloy after the high-temperature hydrogenation step) in a hydrogen atmosphere of 750° C. to 850° C. with a hydrogen partial pressure of 0.5 to 6 kPa. This step allows the magnet alloy to undergo a recombination reaction (reverse transformation reaction) associated with hydrogen desorption. Through this operation, the three-phase decomposition structure becomes a hydride of fine R₂TM₁₄B₁-type crystals (RFeBHₓ) in which hydrogen is removed from the RH₂ phases and the crystal orientations of the Fe₂B phases are transferred. The recombination reaction in this step progresses moderately because it is carried out under a relatively high hydrogen partial pressure. If the high-temperature hydrogenation step and the controlled evacuation step are performed at approximately the same temperature, the high-temperature hydrogenation step can be transitioned to the controlled evacuation step only by changing the hydrogen partial pressure.

(d) Forced Evacuation Step

The forced evacuation step may be preferably performed, for example, at 750° C. to 850° C. in a vacuum atmosphere of 1 Pa or less. This step removes hydrogen remaining in the magnet alloy and completes the hydrogen desorption. The rare-earth anisotropic magnet (or magnet raw material) is thus obtained.

The forced evacuation step may be performed separately from the controlled evacuation step. For example, the forced evacuation step may be performed in a batched process for the cooled magnet alloy after the controlled evacuation step. Rapid cooling is preferred for cooling after the forced evacuation step in order to suppress the growth of crystal grains.

(3) Diffusion Treatment

The diffusion treatment forms non-magnetic phases on the surfaces or grain boundaries of the R₂TM₁₄B₁-type crystals to improve the coercive force of the magnetic particles.

The diffusion treatment is performed, for example, through preparing a mixed raw material (powder) by mixing a diffusion raw material (powder) with the magnet raw material (powder) obtained after the hydrogen treatment of the magnet alloy (mother alloy) and heating the mixed raw material separately in a vacuum atmosphere or an inert gas atmosphere (diffusion step). Alternatively, the magnet raw material and the diffusion raw material may be mixed before the low-temperature hydrogenation step, before the high-temperature hydrogenation step, before the controlled evacuation step, or before the forced evacuation step, and the subsequent step may serve also as the diffusion treatment. The diffusion raw material is, for example, an alloy of a light rare-earth element (e.g., Cu alloy or Cu—Al alloy) or its compound, a heavy rare-earth element (such as Dy or Tb), its alloy or compound (e.g., fluoride), or the like. Light rare-earth element-based diffusion raw materials are more excellent in the supply stability than heavy rare-earth element-based diffusion raw materials.

«Application»

The magnet powder is used for various applications. A typical example is a bonded magnet. The bonded magnet is mainly composed of a rare-earth magnet powder and a binder (e.g., binder resin). The binder resin may be a thermosetting resin or a thermoplastic resin. The bonded magnet is formed, for example, by compression molding, injection molding, transfer molding, or the like. The rare-earth anisotropic magnet powder can develop its intrinsic high magnetic properties by being molded in a magnetic field to align.

### EXAMPLES

A number of samples (rare-earth anisotropic magnet powders) having different component compositions were produced and the magnetic properties of each sample were evaluated. The present invention will be specifically described based on such examples.

«Production of Samples»

Samples 1 to 13 and Samples C1 to C3 listed in Tables 1A and 1B (collectively referred to as “Table 1”) were produced by performing the hydrogen treatment (d-HDDR) and the diffusion treatment. Details are as follows.

(1) Raw Materials

Magnet raw materials (magnet powders) and diffusion raw materials listed in Table 1A were prepared.

The magnet raw materials were obtained by subjecting the magnet alloys (mother alloys) having respective component compositions listed in Table 1A to the hydrogen treatment (d-HDDR) to be described later. The magnet alloys were obtained by heating ingots, which were obtained by arc melting in vacuum, at 1100° C. for 20 hours in vacuum (homogenization heat treatment). The magnet alloys were subjected to hydrogen decrepitation (hydrogen partial pressure: 100 kPa×room temperature×3 hours). Further, the decrepitated powders were sieved (classified) in an inert gas atmosphere. The powdered magnetic alloys (−212 μm) thus obtained were subjected to d-HDDR.

For the diffusion raw materials, Nd alloys (compounds) having respective component compositions listed in Table 1A were used. The diffusion raw materials were obtained through hydrogen pulverizing ingots obtained by the book molding method, further wet pulverizing the hydrogen pulverized substances with a ball milling, and then drying them in an inert gas atmosphere. Thus, powdered diffusion raw materials having an average particle diameter of about 6 μm (D50) were obtained.

(2) Hydrogen Treatment (d-HDDR)

After vacuum evacuating the treatment furnace containing the powdered magnet alloys (each 12.5 g), d-HDDR treatment was performed while controlling the hydrogen partial pressure and temperature in the treatment furnace. Specifically, the disproportionation reaction (forward transformation reaction) was caused in the magnet alloys by the high-temperature hydrogenation step (800° C. to 840° C.×20 kPa×4 hours) (disproportionation step).

Then, the controlled evacuation step (840° C.×1 kPa×1.5 hours) of continuously evacuating hydrogen from the treatment furnace and the subsequent forced evacuation step (840° C.×10⁻² Pa×0.5 hours) were performed. Thus, the recombination reaction (reverse transformation reaction) was caused in the magnet alloys (recombination step). After that, the treated substances in the treatment furnace were cooled in the furnace of a vacuum state (cooling step). The treated substances were lightly decrepitated in Ar gas and sieved (classified) to obtain powdered magnet raw materials (−212 μm).

(3) Diffusion Treatment

Each magnet raw material and the corresponding diffusion raw material were mixed in an inert gas atmosphere to obtain a powdered mixed raw material (mixing step). The mixing ratio listed in Table 1A is a mass ratio of each diffusion raw material to the entire mixed raw material (100 mass %). After each mixed raw material was heated in a vacuum atmosphere of 10⁻¹ Pa at 800° C. for 1 hour (diffusion step), it was cooled in the furnace to near room temperature while maintaining the vacuum state (cooling step).

Thus, each magnet powder (sample) having the overall composition listed in Table 1B was obtained. The overall composition listed in Table 1B was calculated from each composition of the magnet raw material and the diffusion raw material and their mixing ratio. Table 1B also lists and exemplifies the total amount: Rt, the first ratio: (Ce+La)/Rt, and the La ratio: La/(Ce+La) as characteristic amounts of the rare-earth elements calculated based on the overall composition. The second ratio: (Nd+Pr)/Rt listed in Table 1A is a value calculated based on the component composition of each magnet raw material (magnet alloy) before the diffusion treatment. The second ratio of the magnet powder after the diffusion treatment was obtained as (100—first ratio) (%).

«Measurement»

Table 1B also lists the magnetic properties (residual magnetic flux density: Br, coercive force: iHc) of each sample measured by a vibrating sample magnetometer (VSM). The measurement was performed after filling a capsule with each magnet powder, magnetically orienting the field (1193 kA/m) in molten paraffin (about 80° C.), and then magnetizing the sample (3580 kA/m). The density of each magnet powder was assumed to be 7.5 g/cm³.

Table 1B also lists the anisotropy ratio of each sample calculated based on the rare-earth element composition and Br listed in Table 1B. The anisotropy ratio was defined as the ratio of Br to saturation magnetization (Bs) (Br/Bs) determined from the overall composition of each magnet powder. It has been confirmed that all the samples have an anisotropy ratio of 0.7 or more and are anisotropic magnet powders. The saturation magnetization (Bs) was obtained from the following formula with a volume fraction of the main phases of 98% (constant).

Bs=0.98{1.6(Nd+Pr)+1.38(La)+1.17(Ce)}/Rt

The rare-earth magnet powder inherently has anisotropy, and it is rare for the rare-earth magnet powder to be completely isotropic (e.g., anisotropy ratio: 0.5 or less). It can be said that the magnet powder having the above-described anisotropy ratio of 0.7 or more has sufficient anisotropy.

«Evaluation»

(1) Effect of Ga

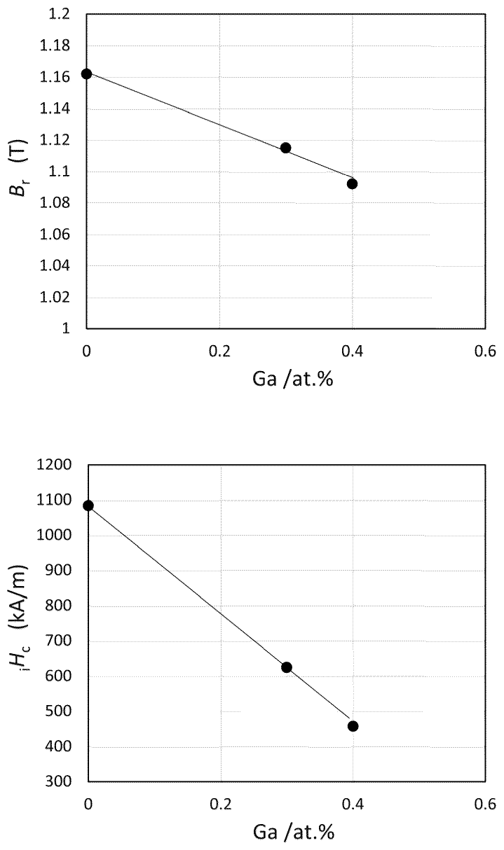

FIG. 1 illustrates the relationship between the magnetic properties and the Ga content based on Sample 7, Sample 13, and Sample C1, which have approximately the same composition.

As apparent from FIG. 1, in the case of magnet powders with a composition system containing a large amount of Ce and La (the first ratio is large), contrary to the conventional common general technical knowledge, it has been newly found that the magnetic properties deteriorate as the Ga content increases.

It has become apparent from FIG. 1 and Table 1 that magnet powders in which Ga is substantially not contained except when contained as an impurity level or the Ga content is 0.35 at % or less in an example or 0.3 at % or less in another example can achieve both the reduction of Nd (Pr) and the high magnetic properties at a high level.

(2) First Ratio

As apparent from a comparison between Samples 1 to 13 and Sample C3 listed in Table 1B, it has become apparent that when the content ratio (first ratio) of R1 (Ce+La) to Rt (total amount of rare-earth elements) is unduly large (e.g., 58% or more in an example or 59% or more in another example), the magnetic properties significantly deteriorate even though Ga is not contained.

(3) La Ratio

As apparent from a comparison between Samples 1 to 13 and Sample C2 listed in Table 1B, it has also become apparent that when the content ratio of La (La ratio) to R1 (total amount of Ce+La) is unduly large (e.g., 37% or more in an example or 39% or more in another example), the magnetic properties significantly deteriorate even though Ga is not contained as in the above case.

From the above, it has become clear that the magnet powder of the present invention achieves high magnetic properties while reducing the usage of Nd and Pr.

TABLE 1A

| | Raw material | | | | | | | | | | | | | | |
|---|---|---|---|---|---|---|---|---|---|---|---|---|---|---|---|
| | Magnet raw material | | | | | | | | | | | | | | |
| | | | | | | | | | | Rare-earth element | | | | | |
| | | | | | | | | | | | Second | Diffusion raw material | | | |
| | | | | | | | | | | Total | ratio | Component | | | |
| Sam- | Component composition | | | | | | | | | amount | (Nd + | composition | | | Mixing |
| ple | (at %/Balance:Fe) | | | | | | | | | Rt | Pr)/Rt | (at %) | | | ratio |
| No. | Nd | Pr | La | Ce | Co | B | Nb | Ga | Cu | (at %) | (%) | Nd | Cu | Al | (mass %) |
| 1 | 6.2 | | 1.60 | 4.69 | | 6.5 | 0.20 | | | 12.5 | 50 | 51.3 | 14.5 | 34.2 | 6 |
| 2 | 6.3 | | 0.78 | 5.47 | | 6.4 | 0.19 | | | 12.6 | 50 | | | | |
| 3 | 6.2 | | 0.30 | 5.94 | | 6.5 | 0.20 | | | 12.4 | 50 | | | | |
| 4 | 6.3 | | 0.02 | 6.24 | | 6.5 | 0.20 | | | 12.6 | 50 | | | | |
| 5 | 6.3 | | 0.01 | 6.25 | | 6.5 | 0.19 | | | 12.6 | 50 | | | | 10 |
| 6 | 5.0 | | 0.38 | 7.13 | | 6.4 | 0.20 | | | 12.5 | 40 | | | | 6 |
| 7 | 7.5 | | 0.26 | 4.76 | | 6.5 | 0.20 | | | 12.5 | 60 | | | | |
| 8 | 7.5 | | 0.26 | 4.76 | | 6.5 | | | | 12.5 | 60 | | | | |
| 9 | 5.9 | 1.5 | 0.24 | 4.75 | | 6.5 | 0.20 | | | 12.4 | 60 | | | | |
| 10 | 6.2 | | 0.02 | 6.24 | | 6.5 | 0.21 | | | 12.5 | 50 | 70.1 | 29.9 | | 6 |
| 11 | 6.3 | | 0.02 | 6.23 | | 6.4 | 0.20 | | | 12.6 | 50 | 80.0 | 20.0 | | |
| 12 | 7.5 | | 0.26 | 4.76 | | 6.5 | 0.20 | 0.3 | 0.1 | 12.5 | 60 | 51.3 | 14.5 | 34.2 | 6 |
| 13 | 7.5 | | 0.25 | 4.76 | | 6.5 | 0.19 | 0.3 | | 12.5 | 60 | | | | |
| C1 | 7.5 | | 0.25 | 4.76 | | 6.5 | 0.19 | 0.4 | | 12.5 | 60 | 51.3 | 14.5 | 34.2 | 6 |
| C2 | 6.3 | | 2.50 | 3.75 | | 6.5 | 0.19 | | | 12.5 | 50 | | | | |
| C3 | 3.8 | | 0.44 | 8.31 | | 6.5 | 0.19 | | | 12.5 | 30 | | | | |

TABLE 1B

| | Rare-earth anisotropic magnet powder | | | | | | | | | | | | | | | |
|---|---|---|---|---|---|---|---|---|---|---|---|---|---|---|---|---|
| | | | | | | | | | | Rare-earth element | | | Magnetic properties | | | |
| | | | | | | | | | | Total | First ratio | La ratio | Residual | Coercive | Saturation | Ani- |
| Sam- | Overall composition | | | | | | | | | amount | (Ce + | La/(Ce + | magnetic fux | force | magnetization | sotropy |
| ple | (at %/Balance:Fe) | | | | | | | | | Rt | La)/Rt | La) | density | Mu | Bs | ratio |
| No. | Nd | Pr | La | Ce | B | Nb | Ga | Cu | Al | (at %) | (%) | (%) | Br (T) | (kA/m) | (T) | Br/Bs |
| 1 | 8.0 | | 1.50 | 4.50 | 6.2 | 0.19 | | 0.6 | 1.4 | 14.0 | 42.9 | 25.0 | 1.099 | 707.6 | 1.41 | 0.78 |
| 2 | 8.1 | | 0.75 | 5.25 | 6.2 | 0.19 | | 0.6 | 1.4 | 14.1 | 42.6 | 12.5 | 1.127 | 900.7 | 1.40 | 0.81 |
| 3 | 8.0 | | 0.31 | 5.70 | 6.2 | 0.20 | | 0.8 | 1.3 | 14.0 | 42.9 | 5.16 | 1.131 | 951.6 | 1.39 | 0.81 |
| 4 | 8.0 | | 0.02 | 6.01 | 6.3 | 0.19 | | 0.6 | 1.4 | 14.0 | 43.0 | 0.33 | 1.130 | 947.0 | 1.39 | 0.81 |
| 5 | 9.2 | | 0.01 | 5.85 | 6.2 | 0.19 | | 0.9 | 2.2 | 15.1 | 38.9 | 0.17 | 1.060 | 994.7 | 1.40 | 0.75 |
| 6 | 6.8 | | 0.36 | 6.84 | 6.2 | 0.19 | | 0.6 | 1.4 | 14.0 | 51.4 | 5.0 | 1.053 | 734.8 | 1.36 | 0.78 |
| 7 | 9.2 | | 0.25 | 4.56 | 6.2 | 0.19 | | 0.6 | 1.3 | 14.0 | 34.3 | 5.2 | 1.162 | 1084.3 | 1.43 | 0.81 |
| 8 | 9.2 | | 0.24 | 4.55 | 6.2 | | | 0.6 | 1.4 | 14.0 | 34.2 | 5.0 | 1.017 | 1167.6 | 1.43 | 0.71 |
| 9 | 7.8 | 1.4 | 0.23 | 4.56 | 6.2 | 0.19 | | 0.6 | 1.4 | 14.0 | 34.2 | 4.8 | 1.165 | 1075.7 | 1.43 | 0.82 |
| 10 | 8.2 | | 0.02 | 6.05 | 6.3 | 0.18 | | 0.9 | 0 | 14.3 | 42.5 | 0.33 | 1.119 | 807.2 | 1.39 | 0.81 |
| 11 | 8.4 | | 0.02 | 6.06 | 6.3 | 0.19 | | 0.6 | 0 | 14.5 | 42.0 | 0.33 | 1.119 | 871.0 | 1.39 | 0.80 |
| 12 | 9.2 | | 0.23 | 4.57 | 6.2 | 0.19 | 0.3 | 0.7 | 1.4 | 14.0 | 34.3 | 4.8 | 1.116 | 625.6 | 1.43 | 0.78 |
| 13 | 9.2 | | 0.24 | 4.56 | 6.2 | 0.19 | 0.3 | 0.6 | 1.4 | 14.0 | 34.3 | 5.0 | 1.115 | 624.5 | 1.43 | 0.78 |
| C1 | 9.24 | | 0.24 | 4.56 | 6.2 | 0.19 | 0.4 | 0.6 | 1.4 | 14.0 | 34.2 | 5.0 | 1.092 | 457.2 | 1.43 | 0.77 |
| C2 | 8.0 | | 2.40 | 3.60 | 6.2 | 0.19 | | 0.6 | 1.3 | 14.0 | 42.7 | 40.0 | 1.038 | 431.3 | 1.42 | 0.73 |
| C3 | 5.6 | | 0.42 | 7.98 | 6.2 | 0.19 | | 0.8 | 1.4 | 14.0 | 59.9 | 5.0 | 0.933 | 461.2 | 1.32 | 0.71 |

1. A rare-earth anisotropic magnet powder comprising magnetic particles, the magnetic particles containing rare-earth elements, boron, and a transition metal element,
the rare-earth elements including a first rare-earth element that comprises Ce and/or La and a second rare-earth element that comprises Nd and/or Pr,
the rare-earth elements having a first ratio (R1/Rt) of 5% to 57%, the first ratio (R1/Rt) being a ratio of an amount (R1) of the first rare-earth element to a total amount (Rt) of the rare-earth elements in terms of the number of atoms,
the first rare-earth element having a La ratio (La/R1) of 0% to 35%, the La ratio (La/R1) being a ratio of an amount of La to the amount (R1) of the first rare-earth element in terms of the number of atoms,
the magnetic particles having a Ga content of 0.35 at % or less with respect to 100 at % as a whole.

2. The rare-earth anisotropic magnet powder according to claim 1, wherein the magnetic particles contain 0.1 to 3 at % of Cu with respect to 100 at % as a whole.

3. The rare-earth anisotropic magnet powder according to claim 1, wherein the magnetic particles contain 0.2 to 3 at % of Al with respect to 100 at % as a whole.

4. The rare-earth anisotropic magnet powder according to claim 1, wherein the magnetic particles contain 0.05 to 0.7 at % of Nb with respect to 100 at % as a whole.

5. The rare-earth anisotropic magnet powder according to claim 1, wherein the total amount (Rt) of the rare-earth elements in the magnetic particles is 12 to 18 at % with respect to 100 at % as a whole.

6. The rare-earth anisotropic magnet powder according to claim 1, wherein the magnetic particles comprise: a main phase composed of an R2TM14B1-type crystal (R: rare-earth element, TM: transition metal element); and a grain boundary phase surrounding the main phase.

7. A production method for obtaining the rare-earth anisotropic magnet powder according to claim 1, comprising
a diffusion step of heating a mixed raw material obtained by mixing a magnet raw material having a main phase composed of an R₂TM₁₄B₁-type crystal and a diffusion raw material serving as a raw material of a grain boundary phase.

8. The production method for the rare-earth anisotropic magnet powder according to claim 7, wherein the magnet raw material is obtained through:
a disproportionation step of making a mother alloy absorb hydrogen to cause a disproportionation reaction; and
a recombination step of dehydrogenating and recombining the mother alloy after the disproportionation step.
